(19) United States
(12) Patent Application Publication
(10) Pub. No.: US 2022/0158157 A1
(43) Pub. Date: May 19, 2022

(54) CARBON-METAL ORGANIC FRAMEWORK COMPOSITE, MANUFACTURING METHOD THEREOF, AND LITHIUM AIR BATTERY INCLUDING THE SAME

(71) Applicants: HYUNDAI MOTOR COMPANY, Seoul (KR); KIA CORPORATION, Seoul (KR); Industry-Academic Cooperation Foundation, Yonsei University, Seoul (KR)

(72) Inventors: Sam Ick Son, Suwon-si (KR); Seo Yoon Shin, Incheon (KR); Chang Taek Lee, Incheon (KR); Moo Whan Shin, Seoul (KR)

(73) Assignees: HYUNDAI MOTOR COMPANY, Seoul (KR); KIA CORPORATION, Seoul (KR); Industry-Academic Cooperation Foundation, Yonsei University, Seoul (KR)

(21) Appl. No.: 17/478,427

(22) Filed: Sep. 17, 2021

(30) Foreign Application Priority Data
Nov. 18, 2020 (KR) 10-2020-0154659

(51) Int. Cl. H01M 4/04; H01M 12/06; H01M 4/38

(52) U.S. Cl. CPC H01M 4/049; H01M 2004/027; H01M 4/382; H01M 12/06

(57) ABSTRACT

A method of manufacturing a carbon-metal organic framework composite includes: preparing a mixed solution comprising a metal ion precursor and an organic ligand precursor; forming a Metal-Organic Framework (MOF) on a surface of a carbon support using the mixed solution; and carbonizing the MOF formed on the surface of the carbon support to form a Carbonized Metal-Organic Framework (C-MOF).

### CROSS-REFERENCE TO RELATED APPLICATION

This application claims, the benefit of priority to Korean Patent Application No. 10-2020-0154659 filed on Nov. 18, 2020 in the Korean Intellectual Property Office, the entire contents of which are incorporated herein by reference.

### TECHNICAL FIELD

The present disclosure relates to a carbon-metal organic framework composite, a manufacturing method thereof, and a lithium air battery including the same as a positive electrode and thus having high electrical conductivity and battery capacity.

### BACKGROUND

In recent years, attention to the fields requiring a secondary battery having high capacity, such as an energy storage system, mounted in an electric vehicle has increased. However, lithium ion batteries developed to date have been evaluated to be insufficient to replace fossil fuels and to be put to high-capacity applications due to low energy density thereof. In recent years, therefore, research on a metal air battery, particularly a lithium air battery, has been actively conducted in many of developed countries. The lithium air battery uses oxygen, which is supplied unlimitedly from the ambient air, whereby it is possible to obtain theoretically very high energy density. Theoretical energy density of the lithium air battery is about 3,200 Wh/kg, which is about 10 times that of a lithium ion battery. In addition, the lithium air battery is environmentally friendly, since oxygen is used as an active material. However, lithium air batteries developed to date have critical disadvantages of low discharge capacity and overvoltage due to high polarization. The reason for this is that lithium peroxide (Li₂O₂) generated as a discharge product when a battery is discharged irregularly accumulates on the surface of a positive electrode. A conventional lithium air battery uses a porous material having a dense structure, such as carbon fibers or carbon paper, as the positive electrode. As a result, a discharge product, such as lithium peroxide (Li₂O₂), is formed in the porous structure, whereby movement of oxygen is disturbed, and therefore actual performance is considerably lower than theoretical performance.

The above information disclosed in this Background section is provided only for enhancement of understanding of the background of the invention and therefore it may contain information that does not form the prior art that is already known in this country to a person of ordinary skill in the art.

### SUMMARY OF THE DISCLOSURE

The present disclosure has been made in an effort to solve the above-described problems associated with the prior art.

It is an object of the present disclosure to provide a method of manufacturing a carbon-metal organic framework composite capable of controlling morphology and a carbon-metal organic framework composite having improved electrical conductivity manufactured using the same.

It is another object of the present disclosure to provide a positive electrode manufactured using the carbon-metal organic framework composite and a lithium air battery including the same, wherein the lithium air battery has increased battery capacity.

The objects of the present disclosure are not limited to those described above. The objects of the present disclosure will be clearly understood from the following description and could be implemented by means defined in the claims and a combination thereof.

In one aspect, the present disclosure provides a method of manufacturing a carbon-metal organic framework composite, the method including preparing a mixed solution including a metal ion precursor and an organic ligand precursor, forming a Metal-Organic Framework (MOF) on the surface of a carbon support using the mixed solution, and carbonizing the MOF formed on the surface of the carbon support to form a Carbonized Metal-Organic Framework (C-MOF).

The molar ratio of the metal ion precursor to the organic ligand precursor may be 5 to 3:1.

The metal ion precursor may include at least one selected from the group consisting of nickel (Ni) and cobalt (Co).

The molar ratio of nickel (Ni) to cobalt (Co) may be 4 to 1:1 to 4.

The organic ligand precursor may include functional groups of two or more sites which bind to the metal ion precursor.

The organic ligand precursor may include 2,5-dihydroxyterephthalic acid (DOT).

The forming of the MOF may be performed at 130 to 140° C. for 4 to 24 hours.

The carbon support may include carbon nanofibers.

The forming of the C-MOF may be performed in an inert gas atmosphere at a temperature of 400 to 600° C. for 30 to 90 minutes.

In another aspect, the present disclosure provides a carbon-metal organic framework composite manufactured by a manufacturing method according to an embodiment of the present disclosure, wherein the carbon-metal organic framework composite includes a carbon support and a Carbonized Metal-Organic Framework (C-MOF) formed on the surface of the carbon support.

In a further another aspect, the present disclosure provides a lithium air battery including a positive electrode including a carbon-metal organic framework composite according to an embodiment of the present disclosure, a negative electrode comprising lithium metal, and an electrolyte, wherein the lithium air battery has a capacity per unit area of 3.3 to 4 mAh/cm² and a specific capacity of 2700 to 5000 mAh/g.

Other aspects and embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure.

FIG. 1 is a flowchart showing a method of manufacturing a carbon-metal organic framework composite according to an embodiment of the present disclosure.

FIGS. 2A to 2D are SEM images showing morphologies of carbon-metal organic framework composites manufactured according to Example 1 (FIG. 2B), Comparative Example 1-1 (FIG. 2A), Comparative Example 1-2 (FIG. 2C), and Comparative Example 1-3 (FIG. 2D).

FIGS. 3A to 3D are SEM images showing morphologies of carbon-metal organic framework composites manufactured according to Example 2 (FIG. 3C), Comparative Example 2-1 (FIG. 3A), Comparative Example 2-2 (FIG. 3B), and Comparative Example 2-3 (FIG. 3D).

FIGS. 4A to 4D are graphs showing capacities per unit area and specific capacities of lithium air batteries manufactured according to Example 3 (FIG. 4C), Example 4 (FIG. 4D), Comparative Example 3 (FIG. 4A), and Comparative Example 4 (FIG. 4B).

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The objects described above, and other objects, features and advantages will be clearly understood from the following exemplary embodiments with reference to the attached drawings. However, the present disclosure is not limited to the embodiments and will be embodied in different forms. The embodiments are suggested only to offer thorough and complete understanding of the disclosed contents and sufficiently inform those skilled in the art of the technical concept of the present disclosure.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element or an intervening element may also be present. It will also be understood that, when an element such as a layer, film, region or substrate is referred to as being “under” another element, it can be directly under the other element or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures among other things. For this reason, it should be understood that, in all cases, the term “about” should modify all numbers, figures and/or expressions. In addition, when numerical ranges are disclosed in the description, these ranges are continuous and include all numbers from the minimum to the maximum including the maximum within the range unless otherwise defined. Furthermore, when the range refers to an integer, it includes all integers from the minimum to the maximum including the maximum within the range, unless otherwise defined.

It should be understood that, in the specification, when the range refers to a parameter, the parameter encompasses all figures including end points disclosed within the range. For example, the range of “5 to 10” includes figures of 5, 6, 7, 8, 9, and 10, as well as arbitrary sub-ranges such as ranges of 6 to 10, 7 to 10, 6 to 9, and 7 to 9, and any figures, such as 5.5, 6.5, 7.5, 5.5 to 8.5 and 6.5 to 9, between appropriate integers that fall within the range. In addition, for example, the range of “10% to 30%” encompasses all integers that include figures such as 10%, 11%, 12% and 13%, as well as 30%, and any sub-ranges of 10% to 15%, 12% to 18%, or 20% to 30%, as well as any figures, such as 10.5%, 15.5% and 25.5%, between appropriate integers that fall within the range.

### Method of Manufacturing Carbon-metal Organic Framework Composite

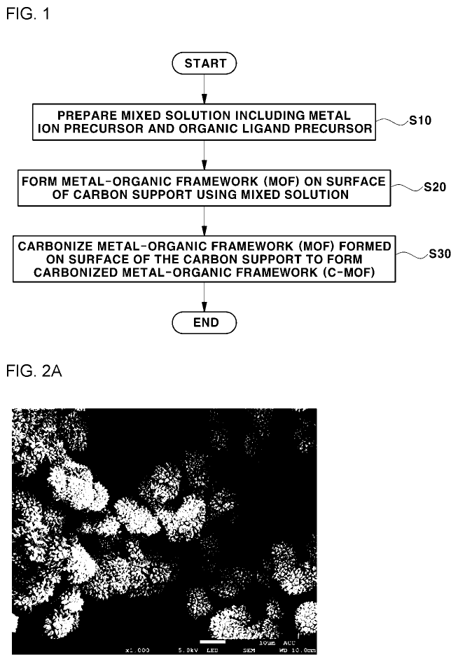

FIG. 1 is a flowchart showing a method of manufacturing a carbon-metal organic framework composite according to an embodiment of the present disclosure. Referring to this, the method of manufacturing the carbon-metal organic framework composite according to the embodiment of the present disclosure includes a step (S10) of preparing a mixed solution including a metal ion precursor and an organic ligand precursor, a step (S20) of forming a Metal-Organic Framework (MOF) on the surface of a carbon support using the mixed solution, and a step (S30) of carbonizing the MOF formed on the surface of the carbon support to form a Carbonized Metal-Organic Framework (C-MOF). The method of manufacturing the carbon-metal organic framework composite according to the embodiment of the present disclosure is characterized in that morphology of the carbon-metal organic framework composite is changed through the optimum precursor concentration and the optimum conditions, whereby electrical conductivity is improved, and a lithium air battery including a positive electrode including the same is characterized in that electric capacity of the lithium air battery is increased.

The step (S10) of preparing the mixed solution is a step of preparing a mixed solution including a metal ion precursor and an organic ligand precursor in order to manufacture a Metal-Organic Framework (MOF).

The metal ion precursor may be a metal ion precursor that can be used in the present disclosure, and may include a metal ion and a metal ion cluster. Specifically, the metal ion precursor may include at least one selected from the group consisting of nickel (Ni), cobalt (Co), zinc (Zn), copper (Cu), iron (Fe), manganese (Mn), chromium (Cr), cadmium (Cd), magnesium (Mg), calcium (Ca), zirconium (Zr), vanadium (V), molybdenum (Mo), aluminum (Al), palladium (Pd), platinum (Pt), gold (Au), silver (Ag), ruthenium (Ru), gadolinium (Gd), europium (Eu), and terbium (Tb). The metal ion precursor may include nickel nitrate hexahydrate including nickel (Ni), cobalt nitrate hexahydrate including cobalt (Co), or a mixture of nickel nitrate hexahydrate and cobalt nitrate hexahydrate, which has high activity as an Oxygen Reduction Reaction/Oxygen Evolution Reaction (OER/ORR) catalyst, although not limited as including a specific metal.

The organic ligand precursor is provided to form an organic ligand serving as an inter-metal linker of the MOF, and the size and shape of the metal-organic framework may be set based on the size and shape of the organic ligand. Functional groups of two or more sites binding to the metal ion precursor may be used as the organic ligand precursor.

The organic ligand precursor may be an organic ligand precursor that can be used in the present disclosure, and may include, for example, at least one selected from the group consisting of 2,5-dihydroxyterephthalic acid (DOT), benzimidazole, carboxylate, phosphonate, amine, azide, cyanide, squaryl, heteroatom, monocarboxylic acid, dicarboxylic acid, tricarboxylic acid, tetracarboxylic acid, imidazole, formic acid, acetic acid, oxalic acid, propanoic acid, butanedioic acid, (E)-butenedioic acid, benzene-1,4-dicarboxylic acid, benzene-1,3-dicarboxylic acid, benzene-1,3,5-tricarboxylic acid, 2-amino-1,4-benzenedicarboxylic acid, 2-bromo-1,4-benzenedicarboxylic acid, biphenyl-4,4′-dicarboxylic acid, biphenyl-3,3′,5,5′-tetracarboxylic acid, biphenyl-3,4′,5-tricarboxylic acid, 2,5-dihydroxy-1,4-benzenedicarboxylic acid, 1,3,5-tris(4-carboxyphenyl)benzene, (2E,4E)-hexa-2,4-dienedioic acid, 1,4-naphthalenedicarboxylic, naphthalene-2,6-dicarboxylate, pyrene-2,7-dicarboxylic acid, 4,5,9,10-tetrahydropyrene-2,7-dicarboxylic acid, aspartic acid, glutamic acid, adenine, 4,4′-bypiridine, pyrimidine, pyrazine, 1,4-diazabicyclo[2.2.2]octane, pyridine-4-carboxylic acid, pyridine-3-carboxylic acid, 1H-benzimidazole, 2-methyl-1H-imidazole, and 4-methyl-5-imidazolecarboxaldehyde. The organic ligand precursor may include 2,5-dihydroxyterephthalic acid (DOT) capable of stably synthesizing an MOF-74 type crystal structure having a large specific surface area, although not limited as including a specific ingredient.

The step (S20) of forming the MOF is a step of forming an MOF on the surface of a carbon support through solvothermal synthesis using the mixed solution.

The MOF is a porous material in which an inorganic node (a metal ion or a metal oxide cluster) and a coordination bond of a multitopic organic linker are cross-interconnected to form a one-, two-, or three-dimensional framework, and is referred to as a porous coordination polymer or a porous organic and inorganic mixture. The metal-organic framework has an open coordination site at the center of a metal as well as well-defined pores so as to be used to collect guest molecules or to separate molecules from each other. Since the metal-organic framework is applicable to an adsorbent, a gas storage material, a sensor, a membrane, a functional thin film, a medicinal substance transfer material, a catalyst, or a catalyst carrier, research on the metal-organic framework has been actively conducted in recent years. However, conductivity of the MOF is insufficient and there is no case in which precursor concentration and synthesis time are controlled to optimize morphology so as to be suitable for a positive electrode for lithium air batteries. The inventors of the present application have found that, in the case in which specific precursor kind, MOF synthesis condition, and CNF surface state are optimized, morphology is changed, whereby it is possible to synthesize a carbon-metal organic framework composite including a large surface area and a large porous structure and having improved electrical conductivity, and have further found that, in the case in which the carbon-metal organic framework composite is appropriately used for a positive electrode for lithium air batteries, it is possible to manufacture a lithium air battery having increased electric capacity. The present disclosure has been completed based on these findings.

A carbon support according to an embodiment of the present disclosure is a support used to manufacture the MOF. Since the MOF is formed on the surface of is the carbon support, nucleation speed is changed depending on the thickness, width, and length of the carbon support. Consequently, an optimization process for manufacturing the carbon support is necessary. That is, the optimization process for manufacturing the carbon support according to the embodiment of the present disclosure includes a step of preparing a polymer solution, a step of electrospinning the polymer solution to manufacture electrospun fibers, a step of stabilizing the electrospun fibers, and a step of carbonizing the stabilized electrospun fibers. Specifically, in the step of preparing the polymer solution, 5 to 15 wt % of polyacrylonitrile is mixed with DMF as a solvent for 5 to 7 hours to manufacture the polymer solution. If the concentration of the polymer solution is less than 5 wt %, spinning is not satisfactorily performed due to an electric field and surface tension. If the concentration of the polymer solution is greater than 15 wt %, a spinning tip is clogged, or a helix-shaped bead or a microribbon-shaped bead may be formed. In addition, if the manufacturing time is less than 5 hours, polyacrylonitrile is not sufficiently mixed, whereby a bead may be formed. In the step of manufacturing the electrospun fibers, the polymer solution may be electrospun to manufacture the electrospun fibers. Electrospinning may be performed at a voltage of 13 to 17 kV for 2 to 4 hours at 450 to 550 rpm at a speed of 1 to 2 ml/h to manufacture the electrospun fibers. If a voltage is less than 13 kV, no Taylor cone is formed, whereby nanofibers are not sufficiently spun. If the voltage is greater than 17 kV, beads or bead nanofibers may be generated due to electrostatic repulsive force. In addition, if a rotational speed is greater than 2 ml/h, nanofibers are loosely formed and tension is increased, whereby fiber diameter is reduced. In the step of stabilizing the electrospun fibers, the electrospun fibers may be stabilized in an air atmosphere for 30 to 90 minutes at a temperature of 200 to 300° C. If the stabilization time is less than 30 minutes, the entire support is not sufficiently stabilized. Further, if the stabilization temperature deviates from the above temperature range, the solvent (DMF) and moisture remaining on the surface of the support may not be sufficiently removed, whereby the chemical structure of the fibers may be changed or the fiber may melt in an ambient atmosphere. In the step of carbonizing the stabilized electrospun fibers, the stabilized electrospun fibers may be carbonized in an inert gas atmosphere, preferably an Ar atmosphere, for 30 to 90 minutes at a temperature of 850 to 950° C. to manufacture the carbon support. The manufactured carbon support may include at least one selected from the group consisting of carbon nanofibers, graphene oxide, graphite, carbon black, Ketjen black, carbon nanotubes, and graphene. The carbon support may include carbon nanofibers, which have a large specific surface area and are capable of functioning as a high-conductivity self-standing support, although not limited as including a specific ingredient.

The MOF may be manufactured using a solvothermal method, in which the carbon support manufactured through the optimization process is included in the mixed solution and reaction is performed at a high temperature and a high pressure, a vapor diffusion method, in which another solvent capable of reducing solubility of the solvent having the precursor dissolved therein is diffused and permeated, or a layer diffusion method, in which a layer is formed between two solutions containing different precursors such that diffusion is performed through the layer. The MOF may be manufactured using the solvothermal method, in which dispersibility is excellent and crystal growth is controlled by adjusting pressure, temperature, a solution, and an additive, although not limited to a specific method.

The step of manufacturing the MOF manufactured according to the embodiment of the present disclosure is a step of securing porosity. Since a carbon-metal organic framework composite having a large surface area and a large porous structure and having improved electrical conductivity through a change of morphology must be synthesized, it is also necessary to optimize precursor ratio and MOF synthesis conditions.

Specifically, morphology of the MOF that is manufactured may be changed through change in molar ratio of the metal ion precursor to the organic ligand precursor included in the mixed solution, whereby it is possible to change pore size and entire distribution. Consequently, the molar ratio of the metal ion precursor to the organic ligand precursor according to the present disclosure may be 5 to 3:1, which is a ratio at which birth and spread growth occurs and MOF crystal growth speed is increased in proportion to increase in concentration, preferably 4.8 to 3.2:1, more preferably 3.28 to 4.76:1. Consequently, the amount of the metal ion precursor may be 0.69 to 8.1 mmol, and the amount of the organic ligand precursor may be 0.21 to 1.68 mmol. If the molar ratio of the metal ion precursor to the organic ligand precursor is less than 3:1, which means that supersaturation concentration is low, the MOF crystal grows in the form of spiral growth, whereby the MOF crystal does not grow, and the crystal growth speed is also very low. Further, if the molar ratio of the metal ion precursor to the organic ligand precursor is greater than 5:1, which means that supersaturation concentration is high, the MOF crystal grows in the form of adhesive growth, whereby not only the MOF crystal grows but also metal atoms in the MOF cohere and are separated, and therefore the performance of the MOF, which is the final product, is reduced. In addition, the size of the crystal of the MOF and nucleation speed may be changed based on the percentage of the solvent included in the mixed solution. Consequently, the ratio of the solute (the metal ion precursor and the organic ligand precursor) to the solvent according to the present disclosure may be 89 to 713:1 for Co or 41 to 330:1 for Ni. If the ratio is less than the above range, metal ions do not react with the organic matter but cohere and are separated as a metal, whereby purity of the MOF is reduced. If the ratio is greater than the above range, the synthesis amount is very small and crystal growth does not sufficiently occur. The solvent may include at least one selected from the group consisting of Deionized (DI) water, methanol, ethanol, propanol, butanol, dimethylformamide, ethylene glycol, tetrahydrofuran, acetone, acetonitrile, benzene, carbon tetrachloride, chloroform, methylene chloride, cyclohexane, dimethoxyethane, diethylformamide, dioxane, ether, ethyl acetate, glycerin, pentane, hexane, heptane, methyl, t-butyl ether, xylene, t-butyl alcohol, and toluene. The solvent may include dimethylformamide, DI water, and ethanol, each of which is a solvent for deprotonating the metal ion precursor and the organic ligand precursor and a solvent for constructing an MOF-74 form, although not limited as including a specific kind.

In addition, synthesis of the MOF may be performed at 130 to 140° C. for 4 to 24 hours. The principle by which the MOF is synthesized may be self-assembly through a decomposition and recombination process between precursor substances due to thermal energy under supersaturation concentration. Specifically, growth of the MOF crystal may occur as the result of Secondary Building Unit (SBU) type small crystals being diffused and added to a nucleus having a predetermined size of more. The precursor substances may be dissolved in a solvent, may be combined in the form of an SBU type crystal nucleus, and may grow through an Ostwald ripening and diffusion process. Decomposition of the precursor substances, formation of the crystal nucleus, and crystal growth are sequentially performed over synthesis time. When concentration in the solvent reaches the maximum level after formation of the crystal nucleus is performed at the early stage of synthesis, crystal growth speed may be the highest. Synthesis time may be 4 to 24 hours. If synthesis is performed for less than 4 hours, crystal growth is not sufficiently performed. If the synthesis time is greater than 24 hours, the precursors are completely decomposed and grow into a crystal, whereby no more reaction is performed. In addition, synthesis temperature may be 130 to 140° C. If the synthesis temperature deviates from the above range, a crystal having a shape other than MOF-74 having a uniform hexagonal column shape may be synthesized.

In addition, washing and drying steps may be further performed after the above step. Washing may be performed using dimethylformamide and ethanol, and drying is performed in an air atmosphere at a temperature of 78.37 to 350° C. for 12 hours or more.

The step (S30) of forming the C-MOF is a step (S30) of carbonizing the MOF formed on the surface of the carbon support to form the C-MOF. A carbon-metal organic framework composite is manufactured through the above step, whereby it is possible to maintain secured porosity while maintaining secured electrical conductivity.

The step of forming the C-MOF may be performed in an inert gas atmosphere at a temperature of 400 to 600° C. for 30 to 60 minutes. The inert gas may be an inert gas that can be used in the present disclosure. The inert gas may be Ar, although not limited as including a specific kind. If carbonization temperature is less than 400° C., the MOF is not sufficiently carbonized. If carbonization temperature is greater than 600° C., the MOF is severely deformed. Furthermore, if carbonization time deviates from the above range, the metal-organic framework is not sufficiently carbonized.

That is, the method of manufacturing the carbon-metal organic framework composite according to the present disclosure has an advantage in that morphology of the carbon-metal organic framework composite is changed, whereby it is possible to obtain a carbon-metal organic framework composite having improved electrical conductivity.

### Lithium Air Battery Including Carbon-Metal Organic Framework Composite

A carbon-metal organic framework composite according to an embodiment of the present disclosure may be manufactured by the method of manufacturing the carbon-metal organic framework composite, and may include a carbon support and a C-MOF formed on the surface of the carbon support.

The carbon-metal organic framework composite according to an embodiment of the present disclosure may have a specific surface area of 125 to 573 m²/g and a pore volume of 0.03 to 0.25 cc/g. That is, morphology of the carbon-metal organic framework composite manufactured by the manufacturing method is changed in order to maintain secured porosity, whereby it is possible to improve electrical conductivity of the carbon-metal organic framework composite.

A lithium air battery according to an embodiment of the present disclosure may include a positive electrode including the carbon-metal organic framework composite according to the present disclosure, a negative electrode having lithium metal, and an electrolyte. Each of the negative electrode and the electrolyte may be manufactured using material that can be used to manufacture a general lithium air battery, and is not limited to a specific material. The lithium air battery according to the embodiment of the present disclosure may have a capacity per unit area of 3.3 to 4 mAh/cm² and a specific capacity of 2700 to 5000 mAh/g. That is, the lithium air battery including the positive electrode including the carbon-metal organic framework composite according to the embodiment of the present disclosure has an advantage in that the battery capacity thereof is high.

The capacity (mAh/g) is generally calculated by mAh/cm²÷mg/cm²×1000.

Hereinafter, the present disclosure will be described in more detail with reference to examples. However, the following examples are merely an illustration to assist in understanding the present disclosure, and the present disclosure is not limited by the following examples.

### Example 1: Carbon-Metal Organic Framework Composite Manufactured by Changing Ratio of Single Metal Ion Precursor to Organic Ligand Precursor Included in Mixed Solution

(S10) A mixed solution (1C) including a metal ion precursor and an organic ligand precursor was prepared. Specifically, 5.52 mmol of nickel nitrate hexahydrate, as a metal ion precursor, 1.68 mmol of 2,5-dihydroxyterephthalic acid (DOT), as an organic ligand precursor, and dimethylformamide, DI water, and ethanol having a ratio of 1:1:1, as a solvent, were mixed to prepare a mixed solution.

(S20) An MOF was formed on the surface of a carbon support using the mixed solution. Specifically, the carbon support was prepared through the following steps. That is, 10 wt % of polyacrylonitrile was mixed with a solvent (DMF) for 6 hours to manufacture a polymer solution. Subsequently, the polymer solution was electrospun at a voltage of 15 kV for 3 hours at 500 rpm at a speed of 1.5 ml/h to manufacture electrospun fibers (carbon nanofibers). Subsequently, the electrospun fibers were stabilized in an air atmosphere for 60 minutes at a temperature of 200 to 300° C. Subsequently, the stabilized electrospun fibers were carbonized in an Ar atmosphere for 60 minutes at a temperature of 900° C. to manufacture a carbon support.

The manufactured carbon support was introduced into the mixed solution prepared in S10, and a MOF was manufactured using a solvothermal method. Specifically, the mixed solution having the carbon support introduced thereinto was stirred for 6 hours, synthesis was performed at 135° C. for 4 to 24 hours using a solvothermal method. Subsequently, washing was performed using dimethylformamide and ethanol and drying was performed to manufacture the MOF.

(S30) The optimized MOF manufactured using the above method was carbonized such that secured porosity and electrical conductivity thereof were maintained to form a C-MOF. Specifically, carbonization was performed in an inert gas atmosphere, i.e. an Ar atmosphere, at a temperature of 400 to 600° C. for 60 minutes to form a C-MOF. Finally, a carbon-metal organic framework composite having a specific surface area of 572.64 m²/g and a pore volume of 0.25 cc/g was manufactured.

### Example 2: Carbon-Metal Organic Framework Composite Manufactured by Changing Ratio of Composite Metal Ion Precursor to Organic Ligand Precursor Included in Mixed Solution

A carbon-metal organic framework composite having a specific surface area of 572.64 m²/g and a pore volume of 0.25 cc/g was manufactured in the same manner as in Example 1, except that a mixed solution was manufactured by including 5.52 mmol of nickel nitrate hexahydrate and 2.58 mmol of cobalt nitrate hexahydrate as a metal ion precursor, compared to Example 1.

### Comparative Example 1-1 to Comparative Example 1-3: Carbon-Metal Organic Framework Composites Manufactured by Changing Ratio of Single Metal Ion Precursor to Organic Ligand Precursor Included in Mixed Solution

Carbon-metal organic framework composites were manufactured in the same manner as in Example 1, except that, compared to Example 1;

a mixed solution (2C) was manufactured by including 11.04 mmol of nickel nitrate hexahydrate, as a metal ion precursor, and 3.36 mmol of 2,5-dihydroxyterephthalic acid (DOT), as an organic ligand precursor (Comparative Example 1-1);

a mixed solution (1/4C) was manufactured by including 1.38 mmol of nickel nitrate hexahydrate, as a metal ion precursor, and 0.42 mmol of 2,5-dihydroxyterephthalic acid (DOT), as an organic ligand precursor (Comparative Example 1-2); and

a mixed solution (1/8C) was manufactured by including 0.69 mmol of nickel nitrate hexahydrate, as a metal ion precursor, and 0.21 mmol of 2,5-dihydroxyterephthalic acid (DOT), as an organic ligand precursor (Comparative Example 1-3).

### Comparative Example 2-1 to Comparative Example 2-3: Carbon-Metal Organic Framework Composites Manufactured by Changing Ratio of Composite Metal Ion Precursor to Organic Ligand Precursor Included in Mixed Solution

Carbon-metal organic framework composites were manufactured in the same manner as in Example 2, except that, compared to Example 2;

a mixed solution was manufactured by including 6.40 mmol of nickel nitrate hexahydrate and 1.60 mmol of cobalt nitrate hexahydrate as a metal ion precursor (Comparative Example 2-1);

a mixed solution was manufactured by including 5.52 mmol of nickel nitrate hexahydrate and 2.58 mmol of cobalt nitrate hexahydrate as a metal ion precursor (Comparative Example 2-2); and

a mixed solution was manufactured by including 1.60 mmol of nickel nitrate hexahydrate and 6.40 mmol of cobalt nitrate hexahydrate as a metal ion precursor (Comparative Example 2-3).

### Example 3: Lithium Air Battery Manufactured Using Positive Electrode Including Carbon-Metal Organic Framework Composite (Including Single Metal Ions)

A positive electrode was manufactured by wet coating using the carbon-metal organic framework composite manufactured according to Example 1. In addition, a negative electrode was manufactured by including lithium metal, and an electrolyte was manufactured by including DMAc LiTFSI. Finally, a lithium air battery was manufactured.

### Example 4: Lithium Air Battery Manufactured Using Positive Electrode Including Carbon-Metal Organic Framework Composite (Including Composite Metal Ions)

A positive electrode was manufactured by wet coating using the carbon-metal organic framework composite manufactured according to Example 2. In addition, a negative electrode was manufactured by including lithium metal, and an electrolyte was manufactured by including DMAc LiTFSI. Finally, a lithium air battery was manufactured.

### Comparative Example 3 and Comparative Example 4: Carbon Material (CNC) and Carbon Nanofibers (CNF)

A carbon material (CNC) having inhibited defects through heat treatment at 2000° C. was prepared as Comparative Example 3, and carbon nanofibers (CNF) having high specific surface area were prepared as Comparative Example 4.

### Experimental Example 1: Deduction in Optimum Amount or Ratio of Ingredients in Mixed Solution Through Morphologies of Carbon-Metal Organic Framework Composites

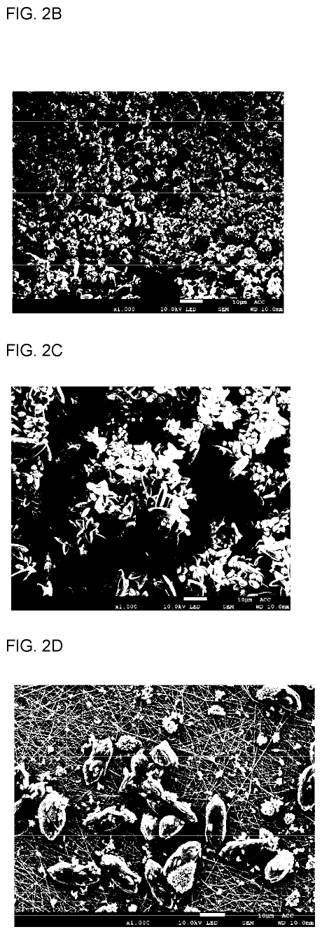

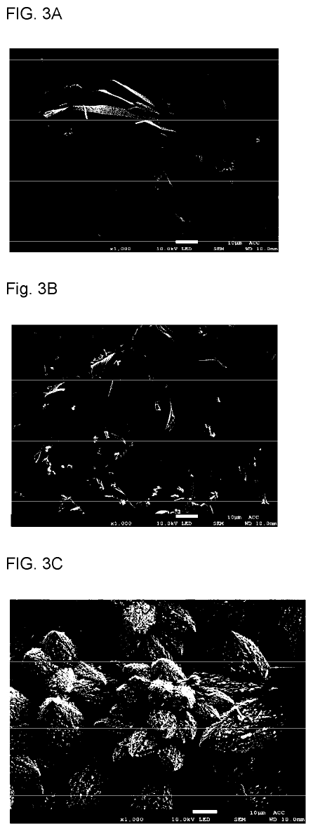

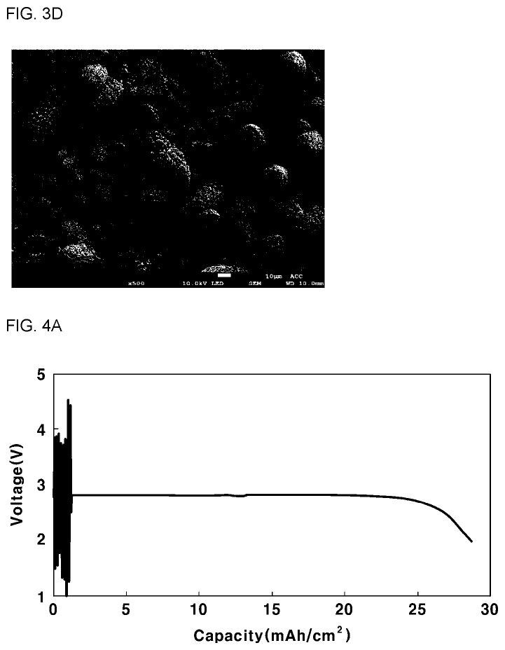

Carbon-metal organic framework composites were manufactured according to Example 1, Example 2, Comparative Example 1-1 to Comparative Example 1-3, and Comparative Example 2-1 to Comparative Example 2-3, and morphologies thereof were analyzed. The results thereof are shown in FIGS. 2A to 2D and 3A to 3D.

Referring to FIGS. 2A to 2D, it can be seen that, when 5.52 mmol of nickel nitrate hexahydrate was used as a metal ion precursor and 1.68 mmol of 2,5-dihydroxyterephthalic acid (DOT) was used as an organic ligand precursor (Example 1; 1C), a carbon-metal organic framework composite manufactured using a single metal ion precursor exhibited morphology having large specific surface area, large pore volume, i.e. high porosity, and high electrical conductivity (FIG. 2B). In contrast, it can be seen that, in carbon-metal organic framework composites of Comparative Example 1-1 to Comparative Example 1-3, when the amount thereof was greater than 1C (Comparative Example 1-1; 2C), not only the MOF crystal grew but also metal atoms cohered and were separated, whereby morphology thereof was unstable (FIG. 2A), and even when the amount thereof was less than 1C (Comparative Example 1-2; 1/4C and Comparative Example 1-3; 1/8C), the MOF) crystal did not sufficiently grow, whereby morphologies thereof were unstable (FIGS. 2C and 2D).

In addition, referring to FIGS. 3A to 3D, it can be seen that, when 5.52 mmol of nickel nitrate hexahydrate and 2.58 mmol of cobalt nitrate hexahydrate were used as a metal ion precursor (Example 2; Co:Ni=1:2.14), a carbon-metal organic framework composite manufactured using a composite metal ion precursor exhibited morphology having large specific surface area, large pore volume, i.e. high porosity, and high electrical conductivity (FIG. 3C). In contrast, it can be seen that, in carbon-metal organic framework composites of Comparative Example 2-1 to Comparative Example 2-3, when the percentage of nickel metal ions was high (Comparative Example 2-1; Co:Ni=4:1) (Comparative Example 2-2; Co:Ni=2.14:1), morphologies thereof were unstable (FIGS. 3A and 3B), and even when the percentage of cobalt metal ions was higher than 2.14 (Comparative Example 1-3; Co:Ni=1:4), not only did the MOF crystal grow but also metal atoms cohered and were separated, whereby morphology thereof was unstable (FIG. 3D).

That is, the present disclosure provides a method of manufacturing a carbon-metal organic framework composite based on the optimum mixing ratio and amount ratio capable of obtaining optimum morphology having excellent porosity and electrical conductivity by changing the mixing ratio or amount ratio of a metal ion precursor to an organic ligand precursor in a mixed solution, and therefore, it is possible to obtain carbon-metal organic framework composite having improved porosity and electrical conductivity through the above manufacturing method.

### Experimental Example 2: Comparison in Capacity per Unit Area and Specific Capacity Between Lithium Air Batteries Manufactured using Positive Electrodes Including Carbon-Metal Organic Framework Composites

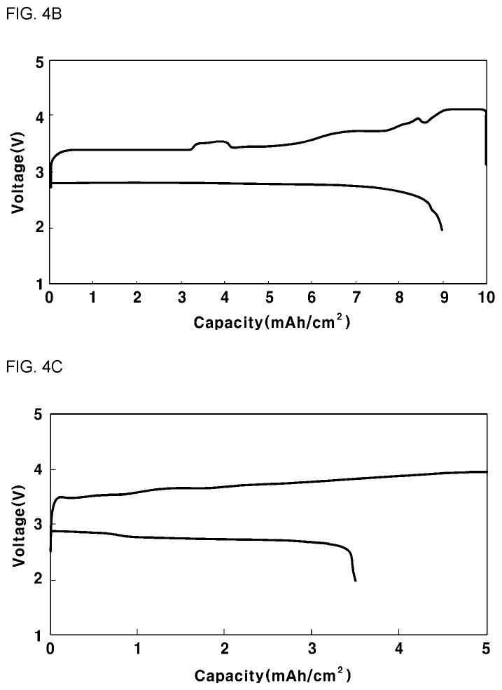

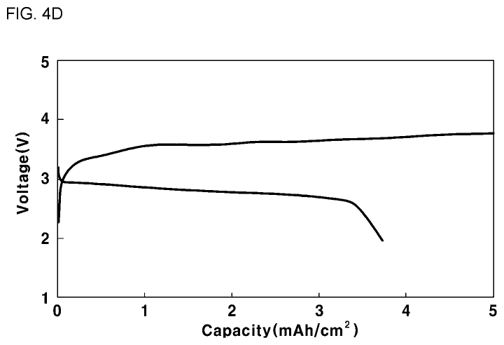

Capacities per unit area and specific capacities of lithium air batteries manufactured according to Example 3 and Example 4 and lithium air batteries manufactured according to Comparative Example 3 and Comparative Example 4 were compared with each other under a low current density condition (0.1 mA/cm²), and the results thereof are shown in FIGS. 4A to 4D.

Referring to FIGS. 4A to 4D, the amounts of carbon loaded into the lithium air batteries manufactured according to Comparative Example 3 and Comparative Example 4 were 9 (Comparative Example 3) and 2.3 (Comparative Example 4), which were higher than the amounts of carbon loaded into the lithium air batteries manufactured according to Example 3 and Example 4, i.e. 0.7 (Example 3) and 1.4 (Example 4). Referring to FIG. 4A, the capacity per unit area and specific capacity of Comparative Example 3 were 8 mAh/cm² and 3111 mAh/g, respectively. Here, for example, according to FIG. 4A, 28 mAh÷9 g*1000=3111 mAh/g. Referring to FIG. 4B, the capacity per unit area and specific capacity of Comparative Example 4 were 9 mAh/cm² and 3883 mAh/g, respectively. Referring to FIG. 4C, the capacity per unit area and specific capacity of Example 3 were 3.5 mAh/cm² and 5000 mAh/g, respectively. Referring to FIG. 4D, the capacity per unit area and specific capacity of Comparative Example 4 were 3.7 mAh/cm² and 2700 mAh/g, respectively. That is, it can be seen that the lithium air batteries manufactured according to Example 3 and Example 4 had lower capacities per unit area than the lithium air batteries manufactured according to Comparative Example 3 and Comparative Example 4 due to smaller carbon loading amounts thereof but had specific capacities equivalent to or higher than those of the lithium air batteries manufactured according to Comparative Example 3 and Comparative Example 4. In particular, the specific capacity of Example 3 was 5000 mAh/g, and therefore Example 3 had relatively high specific capacity although the capacity per unit area thereof was relatively low.

Consequently, the lithium air battery including the positive electrode manufactured using the carbon-metal organic framework composite according to the present disclosure has an advantage in that the battery capacity thereof is high.

As is apparent from the foregoing, the present disclosure relates to a carbon-metal organic framework composite, a manufacturing method thereof, and a lithium air battery including the same as a positive electrode and thus having high electrical conductivity and battery capacity. The method of manufacturing the carbon-metal organic framework composite according to the present disclosure has an advantage in that it is possible to obtain a carbon-metal organic framework composite having improved electrical conductivity by changing morphology of the carbon-metal organic framework composite. In addition, the lithium air battery including the positive electrode manufactured using the carbon-metal organic framework composite according to the present disclosure has an advantage in that the battery capacity thereof is high.

The effects of the present disclosure are not limited to those mentioned above. It should be understood that the effects of the present disclosure include all effects that can be inferred from the foregoing description of the present disclosure.

The present disclosure has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method of manufacturing a carbon-metal organic framework composite, the method comprising:
preparing a mixed solution comprising a metal ion precursor and an organic ligand precursor;
forming a Metal-Organic Framework (MOF) on a surface of a carbon support using the mixed solution; and
carbonizing the MOF formed on the surface of the carbon support to form a Carbonized Metal-Organic Framework (C-MOF).

2. The method according to claim 1, wherein a molar ratio of the metal ion precursor to the organic ligand precursor is 5 to 3:1.

3. The method according to claim 1, wherein the metal ion precursor comprises at least one selected from the group consisting of nickel (Ni),cobalt (Co), and combination thereof.

4. The method according to claim 3, wherein a molar ratio of nickel (Ni) to cobalt (Co) is 4 to 1:1 to 4.

5. The method according to claim 1, wherein the organic ligand precursor comprises functional groups of two or more sites which bind to the metal ion precursor.

6. The method according to claim 1, wherein the organic ligand precursor comprises 2,5-dihydroxyterephthalic acid (DOT).

7. The method according to claim 1, wherein the forming of the MOF is performed at 130 to 140° C. for 4 to 24 hours.

8. The method according to claim 1, wherein the carbon support comprises carbon nanofibers.

9. The method according to claim 1, wherein the forming of the C-MOF is performed in an inert gas atmosphere at a temperature of 400 to 600° C. for 30 to 90 minutes.

10. A carbon-metal organic framework composite comprises:
a carbon support; and
a Carbonized Metal-Organic Framework (C-MOF) on a surface of the carbon support.

11. A lithium air battery comprising:
a positive electrode comprising the carbon-metal organic framework composite according to claim 10;
a negative electrode comprising lithium metal; and
an electrolyte,
wherein the lithium air battery has a capacity per unit area of 3.3 to 4 mAh/cm² and a specific capacity of 2700 to 5000 mAh/g.
